(19) United States
(12) Patent Application Publication
(10) Pub. No.: US 2014/0046785 A1
(43) Pub. Date: Feb. 13, 2014

(54) Credit/Debit Card Secure Processing Method and System

(71) Applicant: Vandester Jenkins, Fayetteville, GA (US)

(72) Inventor: Vandester Jenkins, Fayetteville, GA (US)

(21) Appl. No.: 13/584,092

(22) Filed: Aug. 13, 2012

(51) Int. Cl. G06Q 20/20

(52) U.S. Cl. CPC G06Q 20/206
USPC 705/18

(57) ABSTRACT

Disclosed is a system for substantially enhancing the security and protection of a credit/debit card typically carried by consumers. The system includes administrative mainframe computers at a payment processing center capable of cooperating with a microprocessor embedded credit card, an associated cellular telephone number, a scanner with fingerprint reading means, and inputs by the cardholder. The credit/debit card used in the system comprises embedded electronic data and a means for retaining an electronic image of the thumbprint of the authorized cardholder. When presented for a purchase, and scanned at the point of sale, the scanning equipment will initiate a prompt to automatically dial the cell phone number previously registered by the card holder with the system administrator. Upon recognizing the incoming message, the cardholder enters a pre-arranged PIN into his/her cell phone, thereby uploading all security parameters for verification by the electronic equipment at the point of sale.

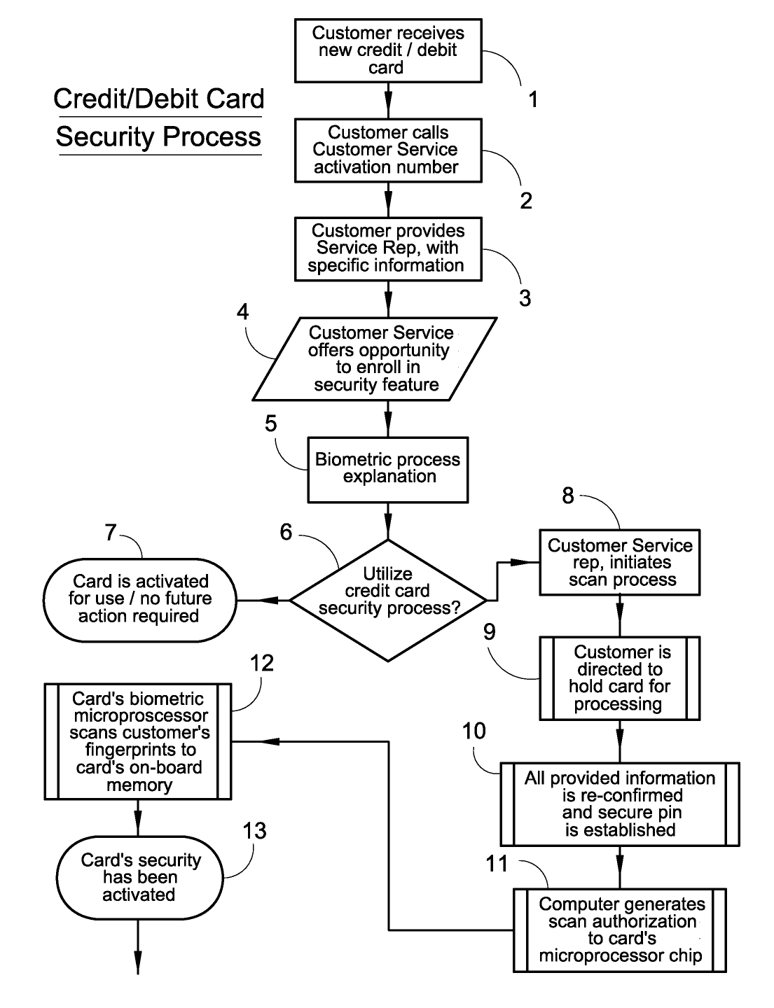

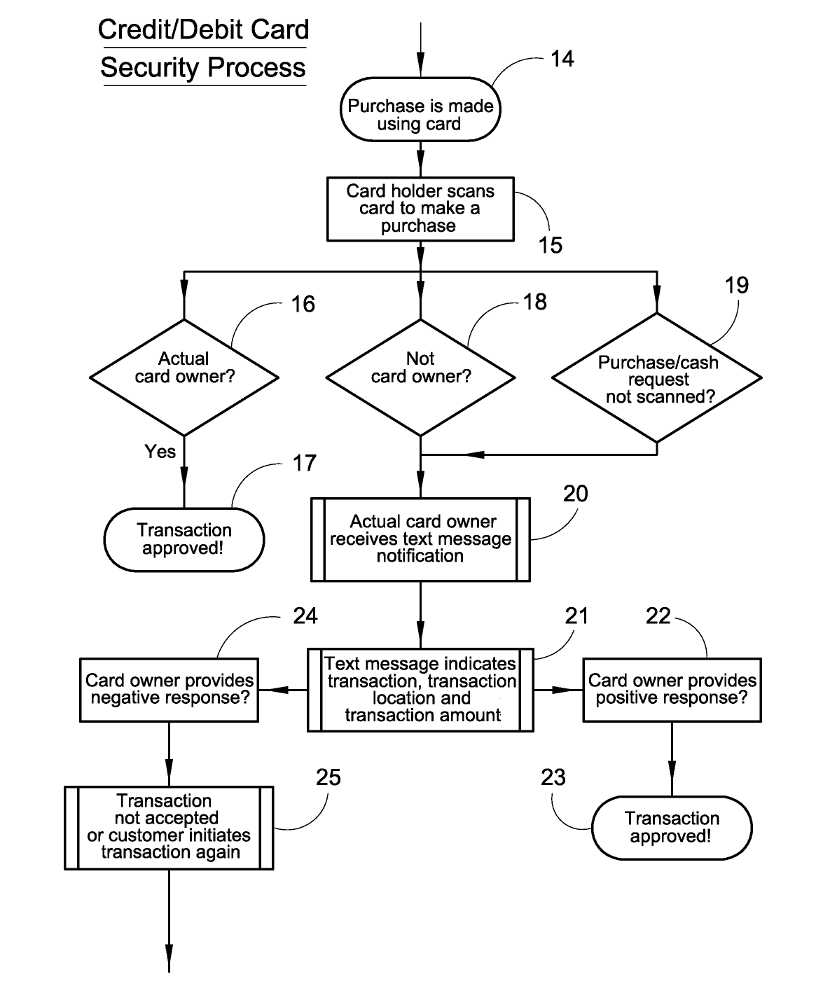

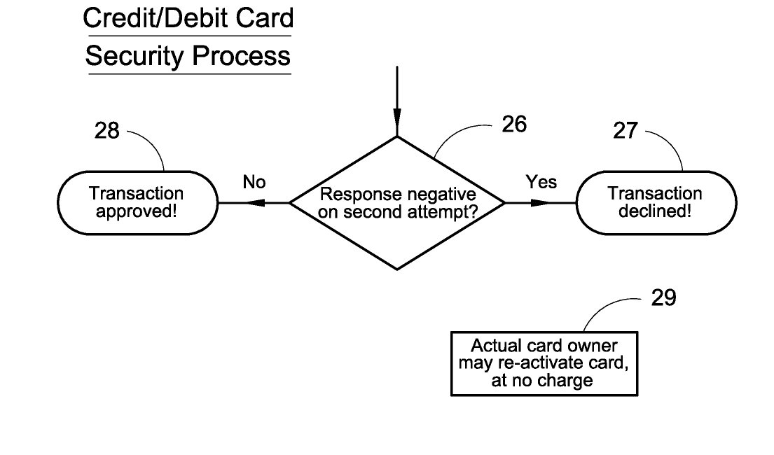

### REFERENCE TO RELATED APPLICATION

Not Applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### BACKGROUND OF THE INVENTION

(1) Field of the Invention

The inventive concept herein is generally concerned with enhancing the security factors surrounding the use of credit and/or debit cards. These cards, often nicknamed “plastic,” are immensely popular both in the United States and other countries worldwide. Consumer purchases, from fast food sandwiches to automobiles, are more often than not completed with credit/debit cards as a convenient medium to complete business transactions without the need of carrying cash or enduring long term periodic payment plans.

As the popularity and universal acceptance of credit cards has grown exponentially, simultaneously the mis-use or unauthorized use of same by unscrupulous persons with criminal intent has become a serious problem costing consumers billions of dollars annually. As the manufacture of illicit credit/debit cards has risen and hundreds of thousands of incidences of identity theft, have occurred in recent years, it becomes more imperative to devise security methods to minimize these negative aspects of card usage.

Total annual credit card fraud actually decreased from 556 billion in 2009 to 537 billion in 2010. While overall fraud declined, consumer out-of-pocket costs rose significantly mainly due to the types of fraud that were successfully perpetrated, and an increase in ‘friendly fraud’ (fraud perpetrated by people known to the victim). The mean amount lost by identity theft fraud, per victim, declined 28% from $4,991,00 in 2009 to $4,607.00 in 2010, yet the mean consumer out-of-pocket cost due to identity fraud increased 63% from $387.00 to $631.00 during the same period.

Credit and debit cards often have embedded within them sensitive data concerning the individual credit card owner. These cards have also increased the awareness of the owner that he/she is carrying personal data which must be secured from individuals having intent to misuse said data. However, the cards with sensitive data requiring personal identification are relatively easy to copy or misuse. Cards having a magnetic strip have proven particularly easy to copy. Many methods to further secure such cards have been adopted in past years, including coding the cards for a spot check at the point of purchase to determine if the credit card may be stolen or counterfeit.

One way of securing said data has concentrated on assigning credit cards with individual multi-digit ID code numbers, e.g. Personal Identification Numbers or PIN's, which the credit card user must keep secret and use at ID-code number checking ATM's. A credit card user carrying several credit cards from different credit card providers will in such cases have to remember and learn by heart several ID-code numbers, which is often difficult, especially if the user is carrying many such credit cards. As a consequence and contrary to credit card provider advice, some users note their ID-code numbers in the vicinity or their credit cards, often being carried in pockets or in the wallet carrying the credit cards.

Though many persons worry about keeping their credit card information secure when shopping online, the top methods that identity thieves use to steal personal data are still low-tech, according to Justin Yurek. president of ID Watchdog, an identity theft-monitoring firm. “Watch your personal documents, be careful to Whom you give out your data over the phone, and be careful of mail theft,” he says.

Indeed, a February 2009 study by Javelin Strategy & Research found that of the 9.9 million identity-theft cases reported in 2008—resulting in a loss of 548 billion—online theft only accounted for 11 percent of incidents. Stolen wallets, checkbooks, and credit and debit cards made up almost half No one is immune to identity theft, but armed with a little knowledge about how identity thieves operate—and a little common sense a customer can stay one step ahead of them.

(2) Description of the Related Art

US 201010332337 discloses a system including computing devices and executable instructions associated with each of an internet content provider, a client system, and a third party administrator. The client system comprises a device fingerprint identifiable by the third party administrator, wherein the third party administrator computer system administers the purchase and sale transaction based on receiving account and payment account information associated with the interne content provider and the client system, respectively.

U.S. Pat. No. 7,778,935 presents a system which employs a credit-card-sized device with integral fingerprint reader, on-board memory with pre-designated card number, infrared coder, power strip, plus at least one magnetic strip (encoded with designated financial account to be used for transactions, including routing number), one magnetic strip for personal medical and identification information and a bar code and photo ID for security. The user simply plugs their card scanner into a multi-function reader, and scans their own fingerprint.

US 2010/0097180 is a system for verifying a credit card user's identification that includes a scanner, a comparator and a control unit. The scanner is configured to scan a holographic fingerprint image on a credit card and a credit card user's fingerprint and output first fingerprint image data representing the holographic fingerprint image and second fingerprint image data representing the credit card user's fingerprint.

U.S. Pat. No. 7,681,232 is an invention being a credit card comprising a card body, which comprises fingerprint reading means providing fingerprint signals representative of at least one fingerprint from a card user, when at least one fingerprint from a card user is pressed against said fingerprint reading means. Said card body further comprises data carrier means holding at least the card owner fingerprint data and secured data, and fingerprint authentication means for activating said secured data.

US 2008/0288405 discloses a system whereby fraud deterrent levels may be automatically selected by a requesting transaction approval entity server (and can be related to level of risk., or security, related to fraud) or may be selected by a consumer. The client can associate their credit card with a specific. device, an e-identity, such as an instant messaging identity, and the e-identity is contacted as a part of finalizing a payment transaction so that a client response of ‘approve’ or reject' can be obtained.

US 2008/0217400 Disclosed is a system which comprises a modified retailer machine that uses a wide variety of security measures that verify the cards and/or person at the time of buying or selling. The system utilizes cellular telephones or electronic devices as a credit card-holding device, which device has a microprocessor computer embedded within the cellular telephone or device. The microprocessor computer can be programmed or operated to selectively turn on or turn off availability of credit card funds without closing the credit card account itself.

US 2008/0120237 is an invention of a system which uses a telephone number code and identification code provided by an account owner to a dealing bank. The telephone number code and identification code are registered and stored in the database of the dealing bank and used as identity-recognizing authorization information for various financial services between the bank and the account owner, in addition to a card number, security code, and the like. Thus, the bank and account owner are protected from monetary loss due to criminal behavior.

US 2007/0075130 presents a method for providing secure transactions with credit cards by adding a fingerprint scanner at the point-of-sale to obtain personal information. The scanner will be integrated with a simple hardware processing device that will process and encode the personal information and compare it to encoded biometric information of the cardholder stored on the card's magnetic strip. The correspondence of user personal information to cardholder biometric information will be a prerequisite for any subsequent transmission of credit card information.

U.S. Pat. No. 7,089,214 Presented is a system whereby a merchant card is provided to a merchant where a charge card transaction is to be conducted. A charge card terminal at the merchant accepts the merchant card and a pin number or cellular phone number from the user conducting the charge card transaction. The phone number or pin number of the customer causes a call to be placed to the cellular phone of a person required to authorize the charge card transaction.

US 2005/0246291 is a patent application wherein the invention is a system which creates a user account record based on biometric information. Information such as a fingerprint scan is provided, and is matched against records stored in a database. Information recalled in that search is compared against non-biometric information provided by a prospective user, thereby providing for the verification of the identity of the prospective user. Based on the verification of the identity of the prospective user, a new user record is created.

US 2002/0178124 Disclosed is a fingerprint identification credit/debit card system where a bitmap generated from a scan of the user's linger, in combination with a user selected and changeable PIN, is the only data associated with the card. The bitmap, or an electronic representation thereof, is stored on the credit/debit card, as well as in the card issuer computer system. The user manually inputs the PIN. If the comparison of the bitmap and PIN presented by the user generates a match with that stored in the card issuer computer, then the user presenting the card is given authorization to use the card for a transaction.

U.S. Pat. No. 6,038,334 presents a method of authenticating a user in dependence upon biometric input information is disclosed. The method allows a user to select biometric information sources and a number of repetitions for each source in order to customize the process of biometric user identification. This method eliminates the occasional error caused by the normal reliance upon only a single instance of biometric information against a template.

U.S. Pat. No. 5,960,100 The invention is a credit card reader with thumb print. verification means is provided including a credit card baying a thin magnetic strip with an account number and a thumb print image stored thereon. Also included is an alert mechanism for providing an indication upon the actuation thereof. A first camera scans the thumbprint image of the credit card. A second camera scans the thumbprint of a person upon receiving an activation signal from a user placing his/her thumb thereon. An image comparison mechanism is adapted to compare the thumb prints and serves to actuate the alert mechanism upon the successful verification of the thumb print of the person with the thumb print image.

### BRIEF SUMMARY OF THE INVENTIVE CONCEPT

The numbers speak for themselves. No matter how diligent consumers are, regarding financial security, there is always someone more aggressive. One way to ensure that the owner of a credit/debit card is one step ahead of those persons committing identity theft and credit card fraud would be to utilize the security processes disclosed herein. By following a six-step procedure, a cardholder will know of attempted access to his/her credit information before a perpetrator completes the intended action. Warning is given in time to foil the crime.

Essentially this system and method substantially enhances the security and identity verification of a credit/debit card of the kind typically carried by consumers. The system includes administrative mainframe computers capable of working in conjunction with a microprocessor-embedded credit card, an associated cellular telephone number, a point-of-sale scanner with fingerprint reading means, and several key inputs by the cardholder. The credit/debit card used in the system comprises embedded electronic data and a means for retaining an electronic image of the thumbprint of the authorized cardholder. When presented for a purchase, and scanned at the point of sale, the scanning equipment will initiate a prompt to automatically dial the cell phone number previously registered by the card holder with the system administrator. It is then incumbent on the cardholder to enter a pre-arranged PIN into his/her cell phone, thereby presenting, all security parameters for verification by the electronic equipment at the point of sale.

### BRIEF DESCRIPTION OF THE VIEWS OF THE DRAWINGS

The objects, features, and advantages of the concept presented in this application are more readily understood when referring to the accompanying drawing sheets. A total of three drawing sheets present a flow chart depicting the basic operational functions at various sequential steps in the security process.

Sheet 1 shows the procedures engaged in by a customer from the initial step of receipt of a new credit/debit card on through the activation or the secure card.

Sheet 2 displays a sequence of alternative events that ma conceivably take place from a merchant's scanning the card for a purchase to a declination of the card, to a second re-scanning and purchase attempt.

Sheet 3 is the flow chart of events occurring when, due to invalid entry of PIN information or mismatching thumbprint image, the purchase is declined and the card is temporarily deactivated.

### DETAILED DESCRIPTION OF THE INVENTIVE CONCEPT

By the system set forth herein, access to a consumer's credit requires the use of nine special numbers that are directly related to the consumer: his/her social security number. Further, the prospective customer must also convey his/her cell or mobile phone number during the information intake process. Thus, the description of the inventive concept begins at this point.

As described beginning at Sheet 1 herein, credit is issued to a customer based on information linked to the customer and the customer's social security account number (SSAN) 3. This number is extremely important and any activity utilizing the SSAN will get the “wheels turning” on a customer's credit, in accordance with this inventive concept. The essence of the inventive concept is to link a customer's SSAN directly to the customer's email address and cell phone number. By this means, any and every transaction involving a customer's SSAN will require the customer's approval.

Upon a customer receiving a new credit/debit card 1, the security service's customer service department must be contacted by telephone 2 from the customer's home phone to initiate the card activation process. The customer service representative will make inquiries of the customer in order to obtain certain minimal information 3. The service representative limber ensures that the potential cardholder's information coincides with the same items of information entered during the credit application intake process.

The customer's cell phone number and information on the application form will be compared and confirmed during the initial phone call. At this time, the Customer Service Representative offers to potential card holder the opportunity to enroll in the unique card security service offered by their company 4. The customer will then make a decision whether he/she desires to utilize the existing credit/debit card security process. The disclosed security service incorporates a system of biometric scanning of a customer's fingerprint(s), to be scanned into the card's “on-board” microprocessor memory 5. The customer is informed that the scan is a one-time activation process initiated at time of acceptance of security feature 6. Should the customer decline the biometric security feature, the card will nevertheless be activated for use, with no further action required, and without the benefit of the card's security system 7.

If the customer indicates an acceptance of the enhanced security system 6, he/she will be given a detailed verbal synopsis and printed explanatory materials regarding the function and capabilities of the card's security system. In particular, a briefing is given on the system's biometric technology, which is predicated on the uniquely distinguishable features of the customer's thumb print 6.

Should the customer decide to accept the enhanced biometric-based security system 6, the customer service representative will, through the use of proprietary software, activate the internet microprocessor circuitry that is embedded in the construction of the customer's card 8. The customer will be directed to hold his/her card firmly, ensuring that the lingers of either hand are pressed tightly to the card “body,” with the thumb pressed over the card's logo 9. All the initial information that was previously given by the customer is re-confirmed and a secure personal identification number (PIN) is established for the customer 10.

A computer utilizing proprietary software generates a scan authorization to the microprocessor chip that is embedded in the customer's card 11. The internal scanner will have the capacity to scan the holder's fingerprints from any location on the card and into the card's “on-board” microprocessor memory, Once the scan has been completed, the digitalized electronic images will be embedded in the card stock and, at the same time, uploaded to the customer service computer server and stored, along with the customer's security information previously provided 12. The complete security system is now in place and fully activated 13 or the customer's use.

Moving to Sheet 2 of the drawing figures herein, the consumer may now proceed to make purchases anywhere the card is accepted 14. As customary, the customer must scan the credit/debit card by use of the card reader at the point-of-sale location 15, utilizing the normal swiping/scanning process 15. Once the card is scanned, assuming the seamier is the actual card owner 16, the transaction is automatically approved as normal 17. If the card is scanned by anyone other than the actual holder 18 or, if the credit/debit card number is used for purchases/cash withdrawal without being scanned 19, the card's actual holder will receive, within less than a five (5) second window, an automated text message to his/her cell phone number that was provided, at time of activation 20. By means of the card internal microprocessor, a prompt is sent to electronically dial the customer's cell phone. At this point, the customer must enter his pre-designated PIN in his cell phone as approval of the purchase

It is pointed, out that at this juncture, if a person other than the thumb-printed cardholder is attempting the purchase, the registered cardholder's cell phone will ring, regardless of who has possession of the cell phone. Without the PIN entry the transaction will not process. If an un-printed (thumbprint) person has possession of the card, and without current possession of the cardholder's cell phone, there will be no means of entering the corresponding PIN and the card will be declined 20.

Referring to Sheet 2, flow chart step 20, there are a number of general reasons why this inventive concept will foil an attempt at purchase, regardless of whether a legitimate attempt or an act by a person bent on credit card theft is taking place:

(a) the authorized cardholder has made an errant entry at the time of purchase;

(b) the authorized cardholder is not in possession of his/her cell phone at the point-of-sale transaction;

(c) a malfunction of the card scanning equipment has occurred;

(d) a person, with the cardholder's permission but with a non-matching thumbprint, is attempting to scan the card.; or

(e) a thief is attempting an act of credit card fraud.

The automated text message sent to the card holder's cell phone will indicate the transaction amount and location of transaction, and request the card holder to confirm or deny transaction 21. If the cardholder's response is positive 22 or a YES response, then the transaction is approved 23. If the card holder's response is negative 24 or a NO response, then the transaction is not accepted and will need to be re-initiated 25.

Assuming that a second purchase attempt will be made, the card holder must again scan the credit/debit card by use of the card reader at the point-of-sale location, as depicted on Sheet 3. If, on the second attempt, the response is negative 26 or NO the transaction is declined and the card is temporarily de-activated 27, If this second purchase attempt is by the registered card holder, be/she will enter the PEN in the cell phone to begin the next sequential step for verification of an authorized purchase. Further, should the cardholder's pre-registered data not match the information inserted on the second attempt, the second attempt at purchase will be declined and the card is temporarily deactivated 27. If the PIN, thumbprint, and other data are a match, the second attempt at purchase will be approved 28.

In the event of card deactivation, the card owner may contact customer service to reactivate the card 29 with no additional charges incurred. The system administrator or customer service must establish conclusively that the individual applying to reactivate the card is the actual owner, and once this is accomplished the reactivation process will be completed. The disclosed card security system also provides that, if the individual attempting reactivation is not the original card holder, authorities will be contacted and use of the card will be electronically “locked.”

While preferred embodiments of the present inventive concept have been shown and disclosed herein, it will be obvious to those persons skilled in the an that such embodiments are presented by way of example only and not as a limitation to the scope of the inventive concept. Numerous variations, changes, and substitutions may occur or be suggested to those skilled in the art without departing from the intent, scope, and totality of this inventive concept. Such variations, changes, and substitutions may involve other features which are already known per se and which may be used instead of, or in addition to features already disclosed herein. Accordingly, it is intended that this inventive concept not be limited by the scope of the accompanying claims, but by the entirety of the disclosure presented.

What is claimed is:

1. A system for authorizing the holder of a specialized credit or debit card to engage in a plurality of secured sales transactions, comprising
(a) a machine programmed to scan a human fingerprint and translate same into a stored electronic image;
(b) a specialized credit/debit card comprising an embedded microprocessor, the capability of storing an electronically scanned human fingerprint, and a magnetic strip;
(c) a plurality of retail sales terminals networked within an electronic transaction system, the electronic transaction system being configured to interface with the specialized charge card for the purpose of conducting the retail sale;
(d) at least one cellular phone having an imbedded microprocessor;
(e) a computer capable of detecting the use of the specialized credit/debit card at a central processing payment server, the payment server using a previously registered phone number. PIN number, and thumbprint as components of a database which stores said card holder information as secured data for verification of the person authorized to use the specialized card , utilizing the phone number or pin number to cause a call to be placed to the cellular phone of a person required to authorize the specialized card transaction.

2. A method for allowing a credit/debit card holder to engage in a plurality of secured credit/debit card sales transactions comprising the steps of
(a) utilizing a specialized card comprising an embedded microprocessor, a digitally-stored thumbprint of said card holder, and a magnetic strip;
(b) establishing a plurality of retail sales terminals networked within an electronic transaction system;
(e) establishing, the electronic transaction system being configured to interface with the specialized charge card for the purpose of conducting the retail sale;
(d) providing a plurality of merchants where such sales transactions may be conducted;
(e) accepting, at a sales terminal for the merchant where the retail card transaction is to be conducted to accept the credit/debit card, a PIN, a cellular phone number, and a digitalized thumbprint image from the user conducting the specialized card transaction,
(f) detecting the use of the specialized credit/debit card at a central processing payment server, the payment server using a previously registered phone number, PIN, and thumbprint as components of a database which stores said card holder information as secured data for verification of the person authorized to use the card;
(g) storing of a database/record of whether the authorizer's cellular phone has an imbedded capability of utilizing the phone number or pin number to cause a call to be placed to a cellular phone of a person required to authorize the charge card transaction, sending a report of the user's charge card transaction to the cellular phone; and
(h) authorizing approval of the charge card transaction back to the merchant's charge card terminal only upon approval by the authorized card holder, the authorizing card holder approving the transaction by entering a PIN into the cellular phone.
